(19) United States
(12) Patent Application Publication
(10) Pub. No.: US 2026/0259307 A1
(43) Pub. Date: Sep. 3, 2026

(54) INFORMATION PROCESSING APPARATUS, INFORMATION PROCESSING METHOD, AND MEASUREMENT SYSTEM

(71) Applicant: SONY GROUP CORPORATION, Tokyo (JP)

(72) Inventors: Toshio YAMAZAKI, Tokyo (JP); Yasuhiro SUTOU, Tokyo (JP); Kentaro DOBA, Tokyo (JP); Seungha YANG, Tokyo (JP)

(21) Appl. No.: 18/872,844

(22) PCT Filed: May 29, 2023
(86) PCT No.: PCT/JP2023/019858

§ 371 Date: Dec. 9, 2024

(30) Foreign Application Priority Data
Jun. 17, 2022 (JP) 2022-097837

(51) Int. Cl. G01S 7/497; G01S 17/86; G01S 17/89; G01S 17/931

(52) U.S. Cl. CPC G01S 7/497; G01S 17/86; G01S 17/89; G01S 17/931

(57) ABSTRACT

The present technology relates to an information processing apparatus, and information processing method, and a measurement system that enable calibration with high accuracy relating to relative positions/postures of a plurality of sensors that senses spatial information regardless of the type, sensing range, and the like of each sensor. A relative positional relationship between a first sensor and a second sensor is calculated on the basis of third sensor data obtained by a third sensor that measures three-dimensional information regarding a calibration object disposed in at least part of measurement ranges of the first sensor and the second sensor that measure spatial information, and first sensor data and second sensor data that are respectively acquired by the first sensor and the second sensor.

### TECHNICAL FIELD

The present technology relates to an information processing apparatus, an information processing method, and a measurement system and particularly to an information processing apparatus, an information processing method, and a measurement system that allow calibration relating to relative positions/postures of a plurality of sensors that senses spatial information to be performed with high accuracy regardless of the type, sensing range, and the like of each sensor.

### BACKGROUND ART

Patent Literatures 1 and 2 disclose a system that calibrates the relative attitude of sensors such as a camera and a lidar (Light Detection and Ranging).

### CITATION LIST

### Patent Literature

Patent Literature 1: Japanese Patent No. 6533619
Patent Literature 2: Japanese Patent Application Laid-open No. 2021-038939

### DISCLOSURE OF INVENTION

### Technical Problem

When sensing spatial information, calibration cannot be performed appropriately depending on the type of sensor or a sensing range in some cases.

The present technology has been made in view of the above-mentioned circumstances and it is an object thereof to allow calibration relating to relative positions/postures of a plurality of sensors that senses spatial information to be performed with high accuracy regardless of the type, sensing range, and the like of each sensor.

### Solution to Problem

An information processing apparatus according to a first aspect of the present technology is an information processing apparatus, including: a processing unit that calculates a relative positional relationship between a first sensor and a second sensor on the basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

An information processing method according to a first aspect of the present technology is an information processing method for an information processing apparatus that includes a processing unit, including: calculating, by the processing unit, a relative positional relationship between a first sensor and a second sensor on the basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

In the information processing apparatus and information processing method according to the first aspect of the present technology, a relative positional relationship between a first sensor and a second sensor is calculated on the basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

A measurement system according to a second embodiment of the present technology is a measurement system, including: a first sensor that measures spatial information; a second sensor that measures spatial information; a calibration object that is placed in at least part of measurement ranges of the first sensor and the second sensor; a third sensor that measures three-dimensional information of the calibration object; and a processing unit that calculates a relative positional relationship between the first sensor and the second sensor on a basis of first sensor data, second sensor data, and third sensor data, the first sensor data and the second sensor data being respectively acquired by the first sensor and the second sensor, the third sensor data being acquired by the third sensor.

In the measurement system according to the second aspect of the present technology, a first sensor measures spatial information, a second sensor measures spatial information, a calibration object is placed in at least part of measurement ranges of the first sensor and the second sensor, a third sensor measures three-dimensional information of the calibration object, a relative positional relationship between the first sensor and the second sensor is calculated on the basis of first sensor data, second sensor data, and third sensor data, the first sensor data and the second sensor data being respectively acquired by the first sensor and the second sensor, the third sensor data being acquired by the third sensor.

### BRIEF DESCRIPTION OF DRAWINGS

FIG. 1 is a diagram illustrating sensors in an automobile to be calibrated by a measurement system to which the present technology is applied.

FIG. 2 is a flowchart showing an example of the procedure when the measurement system to which the present technology is applied calibrates relative positions/postures of the sensors set in the diagram.

FIG. 3 is a diagram describing a common angle of view of the pair.

FIG. 4 is a diagram showing a characteristic location such as an entrance/exit and a path through which people can pass on a floor map.

FIG. 5 is a diagram showing an Example of a calibration object.

FIG. 6 is a block diagram showing a configuration example of a signal processing device in the measurement system to which the present technology is applied.

FIG. 7 is a diagram used to describe a method of calculating a relative position between a measurement device and a lidar.

FIG. 8 is a diagram used to describe a method of calculating a relative position between the measurement device and a camera.

FIG. 9 is a diagram used to describe a method of calculating a relative position between the measurement device and the camera.

FIG. 10 is a diagram used to describe a case where a calibration object that covers the entire sensor to be calibrated is placed.

FIG. 11 is a diagram used to describe a case where a calibration object that covers the entire sensor to be calibrated is placed.

FIG. 12 is a diagram used to describe a case where a calibration object that covers the entire sensor to be calibrated is placed.

FIG. 13 is a diagram used to describe a case where the calibration object is imaged a plurality of times for each of a plurality of sets of sensors.

FIG. 14 is a diagram used to describe a case where the calibration object is imaged a plurality of times for each of a plurality of sets of sensors.

FIG. 15 is a diagram used to describe a case where the calibration object is imaged a plurality of times for each of a plurality of sets of sensors.

FIG. 16 is a diagram used to describe a case where a sensor for an origin is installed.

### MODE(S) FOR CARRYING OUT THE INVENTION

An embodiment of the present technology will be described below with reference to the drawings.

<<Measurement System to which Present Technology is Applied>>

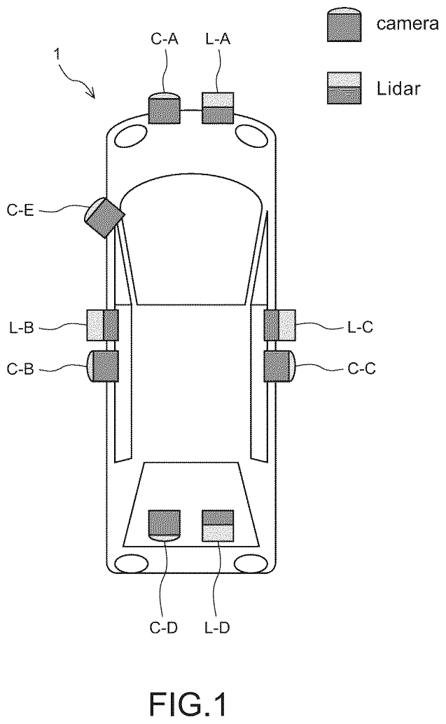

FIG. 1 is a diagram illustrating sensors in an automobile to be calibrated by a measurement system to which the present technology is applied.

In FIG. 1, a vehicle 1 is an automobile vehicle, and five cameras C-A to C-E and four lidars (Light Detection and Ranging) L-A to L-D are installed in the vehicle 1 as sensors that sense (measure or detect) the surrounding environment (spatial information of the peripheral edge of the vehicle 1). Note that in the present specification, sensing spatial information by a sensor is also referred to as image capture in accordance with sensing by a camera. The camera C-A and the lidar L-A are sensors that are installed on the front side of the vehicle 1 to sense spatial information in front of the vehicle 1. The camera C-B and the lidar L-B are sensors that are installed on the left side of the vehicle 1 to measure the left side of the vehicle 1. The camera C-C and the lidar L-C are sensors that are installed on the right side of the vehicle 1 to sense spatial information on the right side of the vehicle 1. The camera C-D and the lidar L-D are sensors that are installed on the rear side of the vehicle 1 to sense spatial information behind the vehicle 1. The camera C-E is a sensor that is installed on the left side of the vehicle 1 to sense spatial information diagonally forward left of the vehicle 1. Note that the number and arrangement of cameras and lidars installed in the vehicle 1 are not limited to those shown in FIG. 1. Further, the type of sensor is not limited to cameras and lidars, and the sensor may be of a type that senses spatial information. Further, the sensor to be calibrated by the present technology is not limited to the sensor installed in the automobile vehicle 1, and may be, for example, a sensor installed in a moving object such as a drone, a self-propelled cart, and a robot, or a stationary object.

### <Calibration of Sensor>

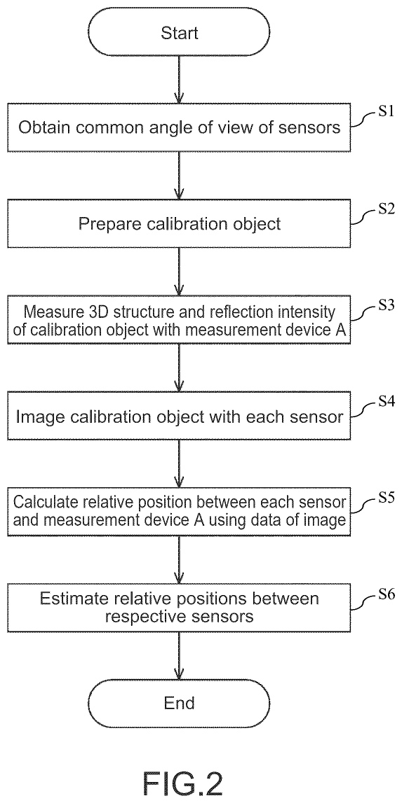

FIG. 2 is a flowchart showing an example of the procedure when the measurement system to which the present technology is applied calibrates relative positions/postures of the sensors installed in the vehicle 1 shown in FIG. 1. First, an overview of the example of the procedure will be described.

In Step S1, the measurement system obtains a common angle of view of two sensors (common angle of view of the pair) for each pair of two sensors.

In Step S2, the measurement system prepares a 3D structure (hereinafter, a calibration object) larger than the smallest common angle of view among the common angles of view for all pairs. A calibration marker for a camera is placed on the calibration object.

In Step S3, the measurement system measures the 3D structure and reflection intensity (or color (wavelength)) of the calibration object with a measurement device A.

In Step S4, the measurement system images the calibration object with each sensor.

In Step S5, the measurement system calculates the relative position between each sensor and the measurement device A via the calibration object.

In Step S6, the relative positions between the respective sensors are estimated.

Note that in the following, the term “relative position” includes not only the position but also the relative relationship of the attitude. That is, the relative relationship between position and attitude (position/attitude) is also referred to simply as a relative position. The calibration of a sensor refers to estimating (calculating) the relative position between sensors. However, the measurement system may estimate only one of the relative position and the relative attitude.

### <Description of Each Step>

### (Step S1)

In Step S1, the two sensors set as a pair are sensors to be calibrated and may be of the same type or different types. Note that in the following, all sensors are assumed to be sensors to be calibrated. Further, since the relative position between two sensors set as a pair is calculated, as described below, the relative positions between all sensors can be calculated by setting one or both of the two sensors set as a pair to be a pair with a sensor of a different pair. Further, sensors that are installed close to each other may be preferentially set as a pair, or sensors whose angles of view (sensing ranges) overlap in a wide range may be preferentially set as a pair. The method of determining two sensors to be set as a pair is not limited to a specific method. Further, two sensors are used as one pair, and the relative position between the paired sensors is calculated by imaging (sensing) the same calibration object. Meanwhile, by imaging the same calibration object with an arbitrary number of (three or more) sensors, the relative positions between these sensors can also be calculated. When an arbitrary number of (two or more) sensors that image the same calibration object are used as one set of sensors, the matters that apply when two sensors are used as one pair can also be applied when an arbitrary number of sensors are used as one set of sensors, similarly. For example, by setting the same sensor as a plurality of sets of sensors, the relative positions between all the sensors in the plurality of sets can be calculated. Therefore, the sensors in all sets can be associated with each other by the sensors belonging to the plurality of sets, and the relative positions between all the sensors to be calibrated can be calculated.

Further, in Step S1, the common angle of view of each pair is obtained. The common angle of view of the pair refers to an angle of view in the overlapping range of angles of view (sensing ranges) of two sensors set as a pair. Since the common angle of view of each pair does not necessarily need to be obtained with high accuracy, it may be calculated in advance using design data relating to the characteristics or the installation positions of the sensors, the installation positions measured after production, or the like.

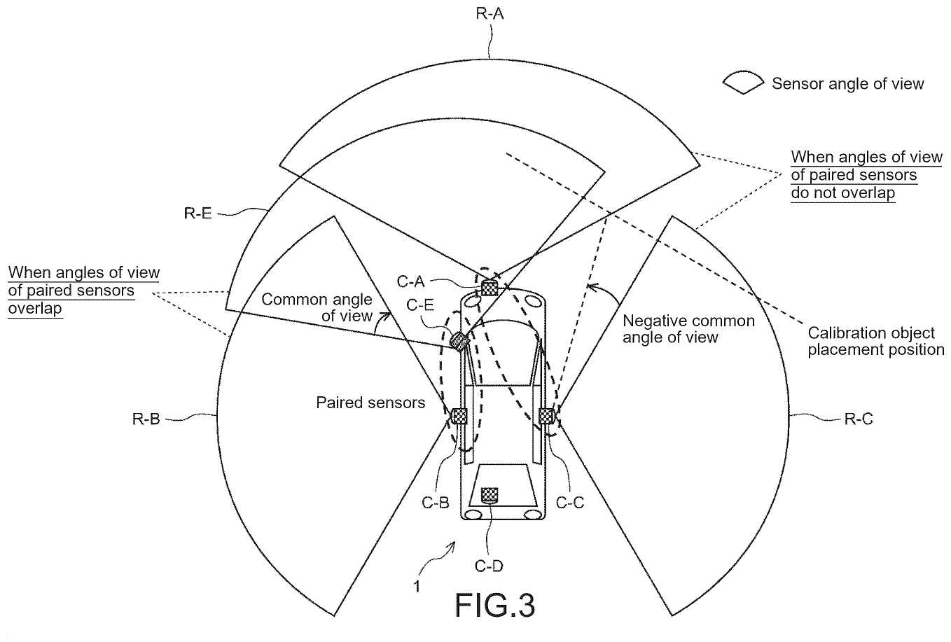

FIG. 3 is a diagram describing the common angle of view of the pair. Note that the components common to those in FIG. 1 are denoted by the same reference symbols and description thereof is omitted. Further, in FIG. 3, only the cameras C-A to C-E are shown as sensors. FIG. 3 illustrates a case where the camera C-B and the camera C-E are set as a pair (hereinafter, referred to as a pair C-BE) and the camera C-A and the camera C-C are set as a pair (hereinafter, referred to as a pair C-AC). Angles of view R-A, R-B, R-C, and R-E respectively illustrate angles of view of the cameras C-A, C-B, C-C, and C-E. Note that the camera C-D is set as a pair with, for example, the camera C-B, which is omitted in this description.

The common angle of view of the pair C-BE is an angle of view in the range where the angle of view R-B of the camera C-B and the angle of view R-E of the camera C-E overlap with each other. The common angle of view of the pair C-AC is a range of an angle of view (angle) where the angle of view R-A of the camera C-A and the angle of view R-C of the camera C-C overlap with each other. However, the size of the common angle of view refers to the size of a common angle of view at the planned placement position (distance from the pair) of the calibration object. Further, there is a pair in which angles of view of two cameras do not overlap with each other at the planned placement position (referred to as a planned placement position or planned placement distance) of the calibration object in some cases. For example, the pair C-AC illustrates a case where the angle of view R-A and the angle of view R-C do not overlap with each other at the planned placement position of the calibration object. In this case, the common angle of view of the pair C-AC is a negative common angle of view. The minimum common angle of view among the common angles of view of the respective pairs is set as the minimum common angle of view and is used as a parameter for the calibration object. Note that the minimum common angle of view of each pair is used to determine the minimum size of the calibration object that allows the sensors of each pair to image the minimum necessary portion of the calibration object.

### (Step S2)

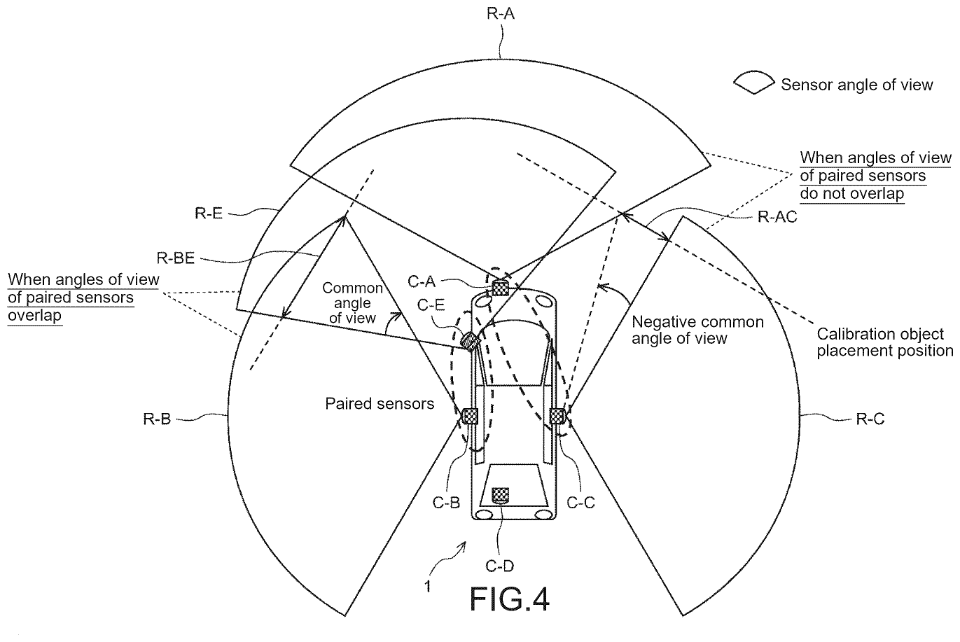

In Step S2, a calibration object necessary for calibration is prepared in consideration of the minimum common angle of view. Here, it is necessary to obtain the minimum size of the calibration object from the minimum common angle of view in consideration of the planned placement distance for calibration. FIG. 4 is an explanatory diagram of the minimum size of the calibration object. Note that in the figure, the components common to those in FIG. 3 are denoted by the same reference symbols and description thereof is omitted.

The size of the calibration object needs to be larger than minimum common angles of view R-BE and R-AC shown in FIG. 4. The minimum common angle of view R-BE is the minimum common angle of view of the pair C-BE. The minimum common angle of view R-AC is the minimum common angle of view of the pair C-AC. The minimum common angle of view of the pair C-AC should be a negative angle because the angles of view of the sensors of the pair do not overlap with each other. Therefore, the size of the calibration object to be used for calibration of the pair C-AC is enlarged to a range that enters angles of view of both the camera C-A and the camera C-C set as the pair C-AC. The enlargement range of the calibration object is expanded until the conditions for the calibration object described below are satisfied.

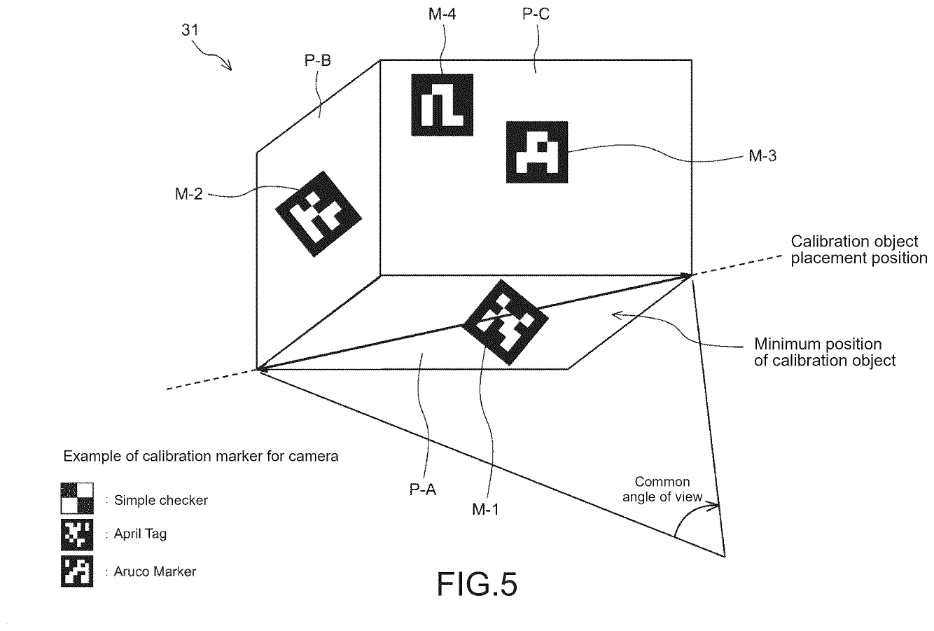

When the size of the calibration object is determined, the calibration object is constructed. The calibration object satisfies, in the case where the calibration object is imaged with a pair of sensors, the following conditions (object conditions) 1 to 3 in the data of the image. Note that the object conditions will be described with reference to Example of the calibration object in FIG. 5.

### (Object Conditions)

1. In the case where a calibration object has a flat surface, it has three or more flat surfaces with one common point. For example, as shown in FIG. 5, a calibration object 31 has two wall surfaces (surfaces P-B and P-C) and one floor surface (surface P-A).

2. In the case where a calibration object has curved surfaces, it has three or more flat surfaces with one common point when each of the curved surfaces is approximated as a plane.

3. Regarding the calibration marker for a camera (hereinafter, referred to also as a marker) placed on the calibration object, when markers are imaged with a pair of two cameras, four or more markers need to be visible in the image taken by each camera. For example, as shown in FIG. 5, four markers M-1 to M-4 are placed on the surfaces P-A to P-C of the calibration object 31. However, the number of markers may be five or more. For example, in the case where the pair has a negative common angle of view, a calibration object on which four or more markers are placed in the angles of view of the two cameras of the pair is used.

The calibration marker for a camera satisfies the following condition (marker condition) 1.

### (Marker Condition)

### 1. The Position of the Marker is Uniquely Determined Among The Markers Detected in the Image.

The phrase “the position of the marker is uniquely determined” means that one point is specified as the position of the marker from the image of the marker. For example, in the case where a checker marker (simple checker) is adopted as the marker as in the example in the lower left of FIG. 5, the intersection of the checker is uniquely determined as the position of the marker, and thus, the checker marker satisfies the marker condition 1.

Further, the position of the marker in the calibration object 31 may be determined manually or may be automatically detected using an automatically detectable marker. There are many published markers that satisfy the marker condition 1 as a calibration marker for a camera. For example, as shown in the example in the lower left of FIG. 5, April Tag, Aruco Marker, and the like can be used as the marker. However, the type of marker is not limited thereto.

### (Step S3)

In Step S3, the calibration object prepared in Step S2 is measured using the measurement device A. The measurement device A outputs measurement data (3D model data) as three-dimensional information indicating the three-dimensional shape (hereinafter, referred to also as the 3D model) of the calibration object. The 3D model data includes, in addition to point cloud data (3D point cloud data) of three-dimensional points (three-dimensional coordinate values), data of the color value at each three-dimensional point or data of reflection intensity of a laser beam in the case where the measurement device A is a measurement device that measures distances using the laser beam. Note that the measurement device A performs measurement at point cloud density that allows the calibration marker for a camera to be identified. As the measurement device A, a commercially available laser ranging sensor or the like can be used.

Here, the calibration object is placed in the range of each common angle of view of the pair as described above. In the case where the common angle of view of the pair is negative, a calibration object having a size that enters the range of angles of view of the sensors of the pair is placed. Then, the calibration object placed for each pair is measured with the measurement device A. At this time, in the case where the entire calibration object cannot be measured with the measurement device A, the measurement position is changed to measure the entire calibration object with the measurement device A. In the case where the entire calibration object can be measured, it is sufficient to perform measurement at least once. Note that at least part of the sensing range (measurement range) of the measurement device A when measuring the calibration object placed for the pair is common to part of the sensing range (measurement range) of the two sensors of the pair.

### (Steps S4 to S6)

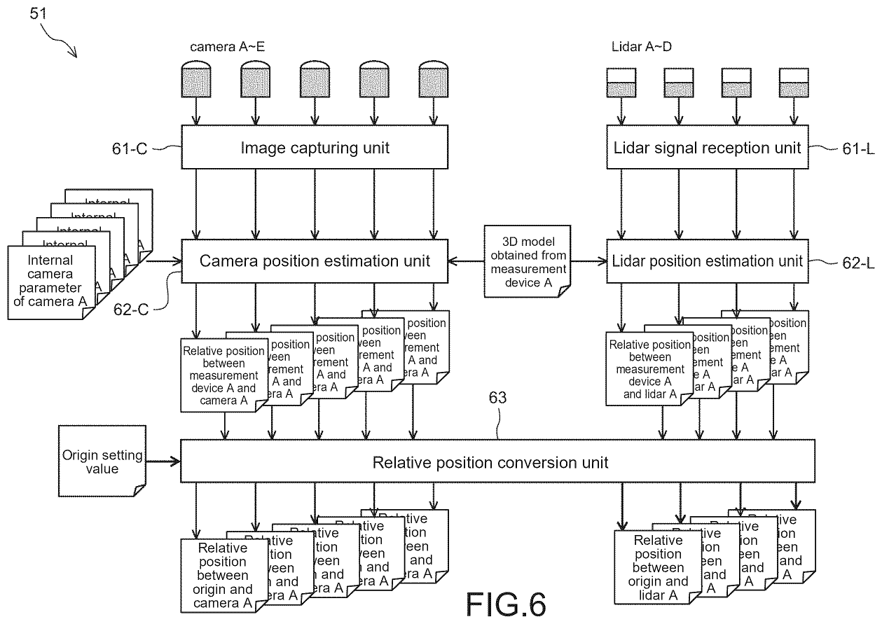

In Steps S4 to S6, the calibration object is imaged (sensed) by each sensor and the relative positions between the sensors are estimated on the basis of the measurement results. The processing of Steps S4 to S6 will be described below with reference to FIG. 6. FIG. 6 is a block diagram showing a configuration example of a signal processing device in the measurement system to which the present technology is applied. In FIG. 6, a signal processing device 51 includes an image capturing unit 61-C, a lidar signal reception unit 61-L, a camera position estimation unit 62-C, a lidar position estimation unit 62-L, and a relative position conversion unit 63.

The image capturing unit 61-C acquires data (image data) of a captured image obtained by imaging a calibration object by the cameras C-A to C-E (cameras A to E) installed in the vehicle 1 in FIG. 1. The image capturing unit 61-C performs general image processing such as shading correction and noise reduction on the acquired image data. The processed image data is supplied to the camera position estimation unit 62-C.

The lidar signal reception unit 61-L receives data (3D point cloud data) of three-dimensional points (3D point cloud) obtained by imaging (measuring) a calibration object with the lidars L-A to L-D (lidars A to D) installed in the vehicle 1 in FIG. 1 and supplies the received data to the lidar position estimation unit 62-L.

The camera position estimation unit 62-C and the lidar position estimation unit 62-L calculates the relative position between each sensor and the measurement device A using the image data supplied from the image capturing unit 61-C and the 3D point cloud data supplied from the lidar signal reception unit 61-L, respectively. Further, the camera position estimation unit 62-C and the lidar position estimation unit 62-L acquire the 3D model data measured by the measurement device A from the measurement device A and use the acquired 3D model data to calculate the relative position between each sensor and the measurement device A.

### (Calculation of Relative Position Between Measurement Device A and Lidar)

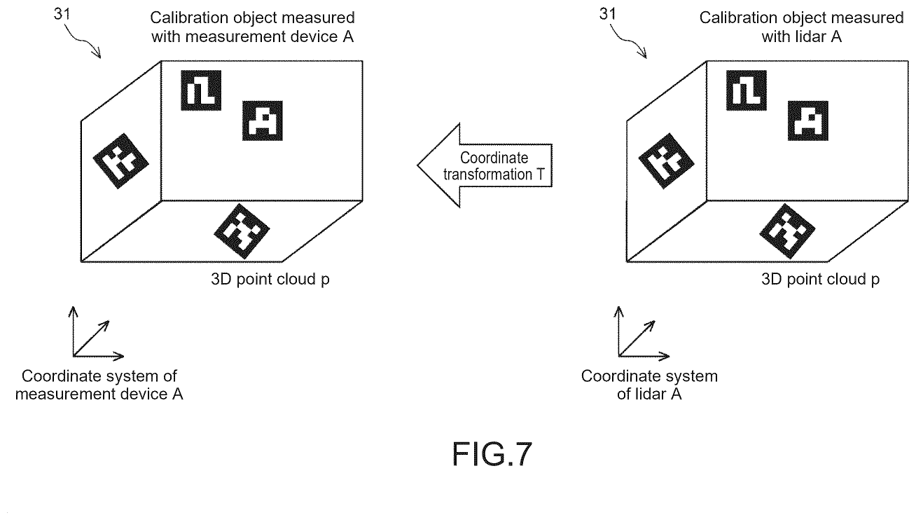

First, the method by which the lidar position estimation unit 62-L calculates the relative positions between the measurement device A and the lidars L-A to L-D on the basis of the 3D point cloud data acquired from the lidars L-A to L-D and the 3D model data acquired from the measurement device A will be described with reference to the conceptual diagram of FIG. 7.

In FIG. 7, the 3D coordinate system on the left side is a coordinate system of the measurement device A, which indicates the 3D point cloud data included in the 3D model data of the calibration object 31 obtained from the measurement device A, and the 3D coordinate system on the right side is, for example, a coordinate system of the lidar L-A, which indicates the 3D point cloud data obtained from the lidar L-A (lidar A). Note that an arbitrary point in the 3D point cloud in the coordinate system of the measurement device A is represented by p (vector), and the point in the coordinate system of the lidar L-A corresponding to the point p is represented by q (vector).

Since the measurement device A and the lidar L-A are different from each other, their coordinate systems differ. However, since the 3D structure of the same calibration object 31 is measured, there is a coordinate transformation T in which the coordinates of one 3D point cloud are transformed to match the coordinates of the other 3D point cloud.

When the origin of each coordinate system is the position of the measurement device A, the coordinate transformation T indicates the relative position with the measurement device A.

The method of obtaining the relative position between two points clouds is known, and the coordinate transformation T is obtained using the known method. For example, the point-to-point ICP algorithm [BeslAndMckay 1992] (Paul J. Besl and Neil D. Mckay, A Method for Registration of 3D Shapes, PAMI, 1992.) obtains the coordinate transformation T by optimizing to minimize the following formula (1).

$$\begin{matrix}[ Math . 1 ] & \\ E ( T ) = \sum {‖ p - Tq ‖}^{2} & ( 1 )\end{matrix}$$

Here, p represents the coordinate value of the 3D point cloud acquired from the measurement device A, and q represents the coordinate value of the 3D point cloud acquired from the lidar.

The lidar position estimation unit 62-L in FIG. 6 calculates the relative position between the measurement device A and each of the lidars L-A to L-D using, for example, the above-mentioned point-to-point ICP algorithm [BeslAndMckay1992] on the basis of the 3D point cloud data acquired from the lidars L-A to L-D and the 3D model data (3D point cloud data) acquired from the measurement device A. The data of the calculated relative position is supplied to the relative position conversion unit 63.

### (Calculation of Relative Position Between Measurement Device A and Camera)

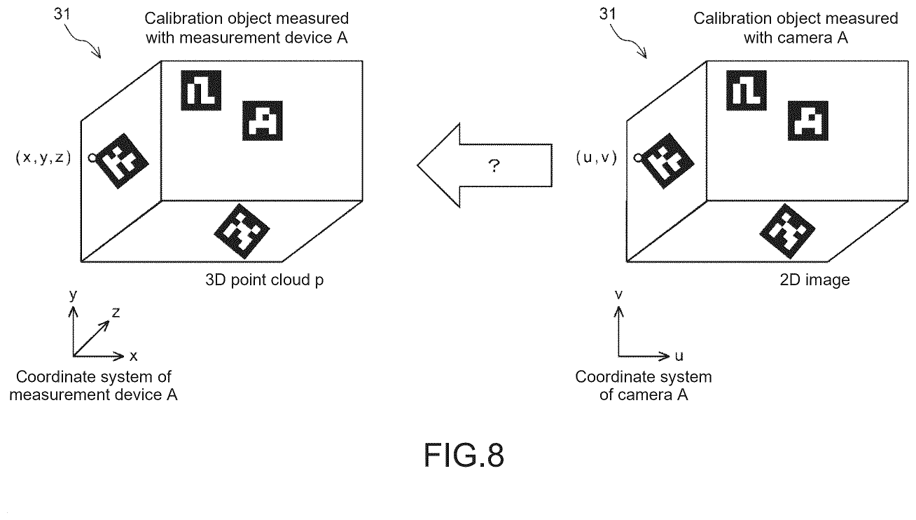

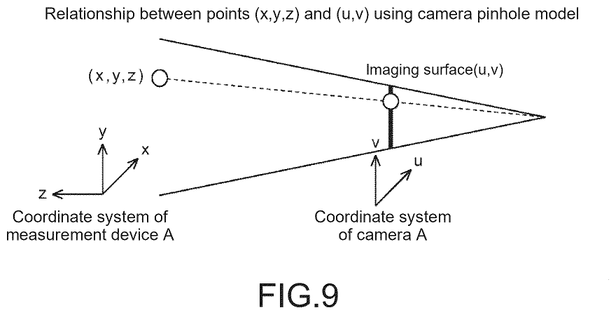

Subsequently, the method by which the camera position estimation unit 62-C calculates the relative positions between the measurement device A and the cameras C-A to C-E on the basis of the image data acquired from the cameras C-A to C-E and the 3D model data acquired from the measurement device A will be described with reference to the conceptual diagrams of FIG. 8 and FIG. 9.

In FIG. 8, the 3D coordinate system on the left side is a coordinate system of the measurement device A, which indicates the 3D model data (3D point cloud data) of the calibration object 31 obtained from the measurement device A, and the 2D coordinate system on the right side is, for example, a coordinate system of the camera C-A, which indicates the image of the calibration object 31 obtained from the camera C-A (camera A). Note that an arbitrary point in the 3D point cloud in the coordinate system of the measurement device A is represented by (x,y,z), and a point in the coordinate system of the camera C-A is represented by (u,v).

Since the image taken by the camera C-A is a 2D image, there is no coordinate transformation T that matches the 3D model unlike the 3D signal. Meanwhile, the correspondence between the coordinates (u,v) of the camera C-A and the coordinates (x,y,z) of the 3D model data in the coordinate system of the measurement device A can be expressed with a pinhole model camera as shown in FIG. 9, and they are in a projective transformation relationship. The relationship between the coordinates (x,y,z) of the measurement device A (3D model data) and the coordinates (u,v) of the camera C-A with the pinhole model is as the following formula (2).

$$\begin{matrix}[ Math . 2 ] & \\ ( \begin{matrix}u \\ v\end{matrix} ) = Π ( K [ T ] ( \begin{matrix}x \\ y \\ z\end{matrix} ) ) & ( 2 )\end{matrix}$$

It is known that in the case where the camera parameter K is known and the correspondence between a plurality of points (x,y,z) and (u,v) is obtained, the relative position between the camera C-A and the measurement device A can be obtained by solving the above formula (2). Here,
Π: projective transformation function
K: camera parameter
T: relative position between the camera C-A and the measurement device A.

This problem is known as the PnP problem and can be solved by a known method. However, the correspondence between (x,y,z) and (u,v) needs to be limited by four or more points.

The camera position estimation unit 62-C in FIG. 6 acquires the positions of four or more markers placed on the calibration object in the 3D model data obtained by the measurement device A and the image data obtained by the camera C-A and obtains the correspondence between (x,y,z) and (u,v) at the four or more points. Then, the camera position estimation unit 62-C calculates the relative position between the camera C-A and the measurement device A using the 3D model data acquired from the measurement device A, the image data of the camera C-A acquired from the image capturing unit 61-C, and the camera parameter of the camera C-A. The camera position estimation unit 62-C calculates the relative position with the measurement device A for all the cameras C-B to C-E, similarly. The data of the calculated relative position is supplied to the relative position conversion unit 63.

### (Calculation of Relative Positions Between Sensors)

When the relative position between the measurement device A and each sensor is calculated in Step S5, the relative position conversion unit 63 calculates (estimates) the relative positions between sensors in Step S6. However, the relative positions between all sensors do not necessarily need to be calculated, an arbitrary position may be defined as the origin or the position of one sensor may be defined as the origin, and the relative position with the origin may be calculated.

First, general coordinate transformation will be described. The rotation and translation from a coordinate system A to a coordinate system B are respectively a 3×3 matrix and a 3×1 matrix, and the following definitions are given.
_{B}R_{A}: 3×3 matrix expressing the rotation from the coordinate system A to the coordinate system B
_{B}P_{A}: 3×1 matrix expressing the translation from the coordinate system A to the coordinate system B

At this time, the transformation from the coordinate system A to the coordinate system B is expressed by the following formula (3).

$$\begin{matrix}[ Math . 3 ] & \\ {}_{B} {T}_{A} = ( \begin{matrix}{}_{B} {R}_{A} & {}_{B} {P}_{A} \\ 0 & 1\end{matrix} ) & ( 3 )\end{matrix}$$

$$however , {}_{B} {R}_{A} ∈ S 03 , {}_{B} {P}_{A} ∈ {R}^{3}$$

Since the formula (3) expresses the relative position/posture as a translation vector and a rotation matrix between coordinate systems, the transformation of the relative position/posture from the measurement device A to the camera is represented by _{C}T_{A}. Similarly, the transformation of the relative position/posture from the measurement device A to the lidar is represented by _{L}T_{A}. _{C}T_{A} and LTA are calculated from the data of the relative position between the measurement device A and each sensor. When the relative position (relative position/posture) between the lidar and the camera at this time is represented by _{L}T_{C}, _{L}T_{C} is expressed by the following formula (4).

$$\begin{matrix}[ Math . 4 ] & \\ {}_{L} {T}_{C} = {}_{L} {T}_{A} \times {}_{A} {T}_{C} = {}_{L} {T}_{A} \times {}_{C} {T}_{A}^{- 1} & ( 4 )\end{matrix}$$

The relative position _{L}T_{C} between the lidar and the camera can be calculated from _{C}T_{A} and _{L}T_{A}. Similarly, the relative position between sensors for which data of the relative position with the common measurement device A has been obtained can be calculated in a way similar to the formula (4). If data of the relative position between any other sensor and the common measurement device A can be acquired, the relative position between the sensors can be obtained using the relationship of the formula (4) even if the number of sensors increases.

Even if an arbitrary position is desired to be set as the origin, the transformation _{O}T_{A} from the measurement device A to the origin and the transformation from an arbitrary sensor to the origin can be calculated, so that the relative position between the origin and the sensor can be calculated using the arbitrary position as the origin.

The relative position conversion unit 63 in FIG. 6 calculates the relative positions between the respective sensors on the basis of the data of the relative positions between the measurement device A and the cameras C-A to C-E from the camera position estimation unit 62-C and the data of the relative positions between the measurement device A and the lidars L-A to L-D from the lidar position estimation unit 62-L as described above. At this time, the relative position conversion unit 63 calculates, in the case where an origin setting value that specifies a specific position as the origin is given, the relative positions between the origin and the respective sensors (the cameras C-A to C-E and the lidars L-A to L-D). The data of the calculated relative positions is supplied to an information processing apparatus (not shown) or the like mounted on the vehicle 1 in which the sensors are installed. The supplied data of the relative positions is used for, for example, calibrating the position of the sensor with high accuracy when using the output data of the sensor in an image recognition device or the like, and is used as a parameter when projecting onto a common origin or output data of each sensor.

### <Placement of Calibration Object>

Although the size of the calibration object has been larger than the minimum size in the above description, it is clear that this condition is satisfied if a calibration object that covers (surrounds) the entire sensor to be calibrated is placed.

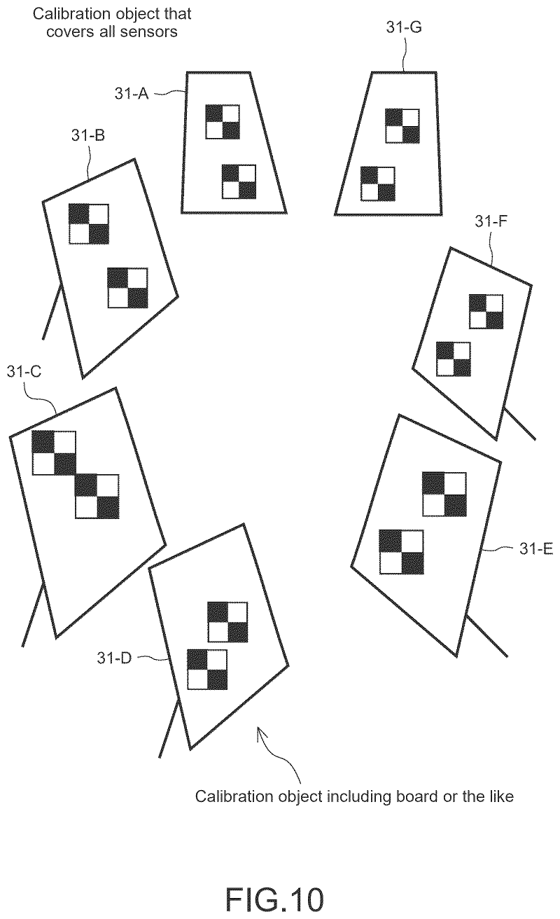

For example, if it is a place where a calibration object can be placed on a regular basis, such as a factory and a service center, such a calibration object can be placed. FIG. 10 to FIG. 12 are each a diagram describing such a case.

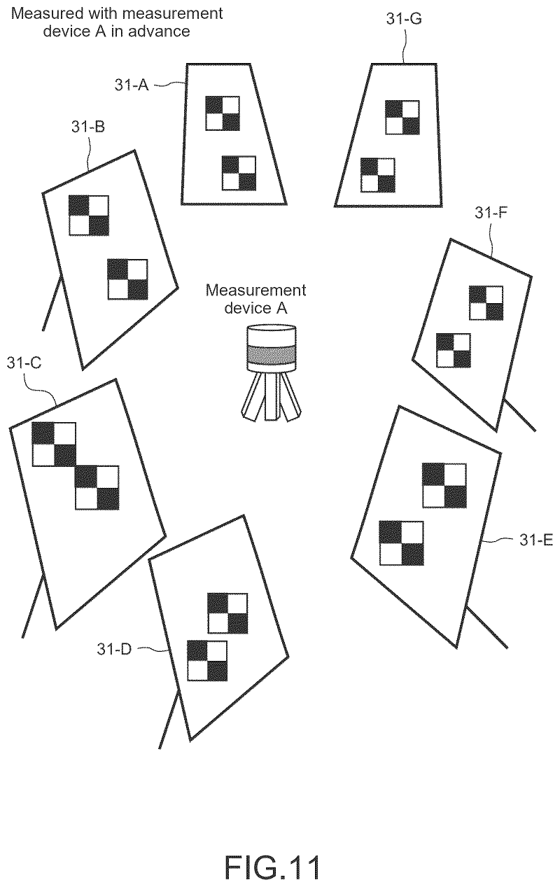

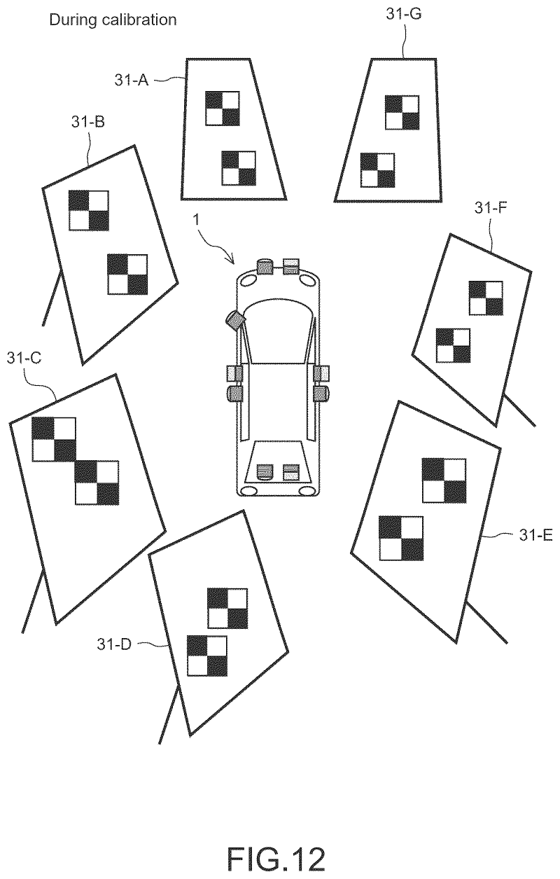

As shown in FIG. 10, in the case where it is desired to calibrate the sensors for measuring the entire periphery as in the vehicle 1 shown in FIG. 1, calibration objects 31-A to 31-G that cover all the target sensors (cover angles of view of all sensors) are placed and the measurement device A is installed near the center of the calibration objects 31-A to 31-G (position where the vehicle 1 in which target sensors are installed is placed) as shown in FIG. 11. Then, the measurement device A performs measurement to acquire the 3D model data. Subsequently, as shown in FIG. 12, by placing the vehicle 1 in which the sensors to be calibrated are installed at a position surrounded by the calibration objects 31-A to 31-G instead of the measurement device A and imaging (measuring) the calibration objects 31-A to 31-G with each sensor, the sensors installed in different vehicles 1 can be sequentially calibrated as long as the calibration objects 31-A to 31-G are not caused to move. In the case where the calibration objects 31-A to 31-G have been caused to move, it only needs to measure the calibration objects 31-A to 31-G again using the measurement device A to acquire the 3D model data again. However, assumption is made that the calibration objects satisfy the above-mentioned object conditions and marker condition when imaging the calibration objects 31-A to 31-G with each sensor.

### Modified Example 1

In the case of the method described with reference to FIG. 10 to FIG. 12, a sufficiently large space is necessary to place a calibration object if the installation range of the sensor to be calibrated is large. In this regard, an example of the procedure in the case where a wide space cannot be provided will be described.

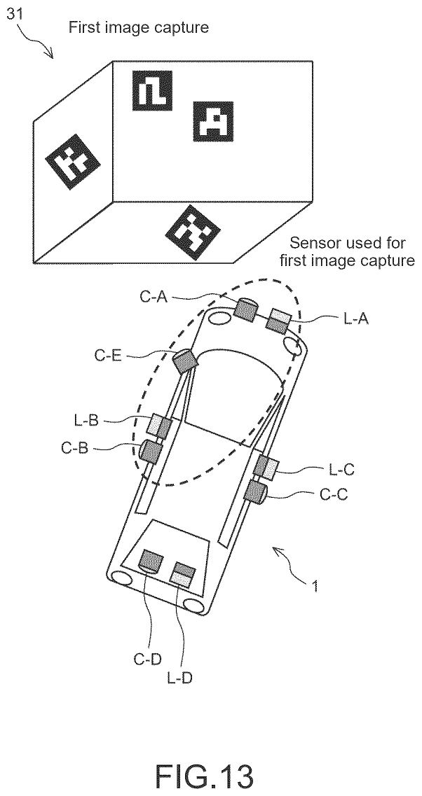

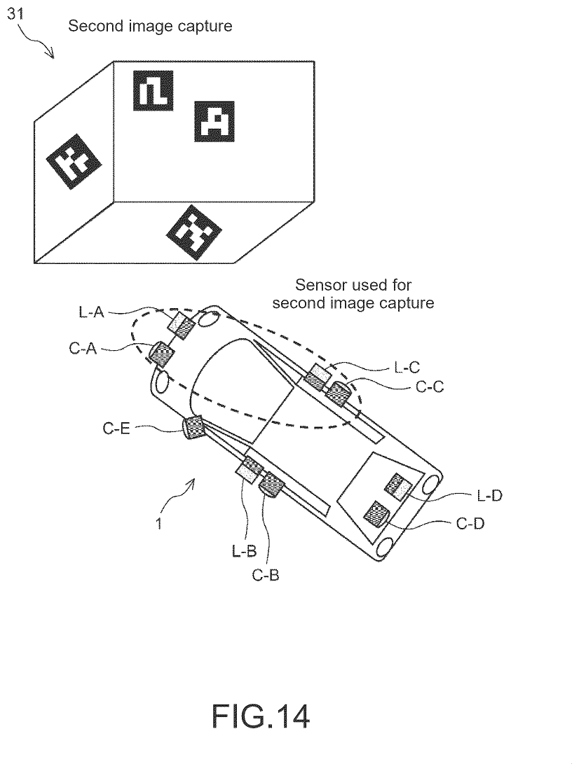

In the case where a calibration object that covers all sensors to be calibrated cannot be placed, the sensors are divided into a plurality of sets and the calibration object is imaged a plurality of times for each set of sensors. In the case where the calibration object is imaged a plurality of times for each set of sensors as in this case, at least one sensor of each set is included in another set. FIG. 13 and FIG. 14 are each a diagram describing such a case.

First, as shown in FIG. 13, the sensors on the front side of the vehicle 1 (the camera C-A and the lidar C-A) and the sensor on the left side (the cameras C-B and C-E and the lidar L-B) are used as one set of sensors, and the calibration object 31 is imaged the first time with these sensors. Subsequently, as shown in FIG. 14, the position of the vehicle 1 is changed, the sensors on the front side of the vehicle 1 (the camera C-A and the lidar C-A) and the sensors on the right side (the camera C-C and the lidar L-C) are used one set of sensors, and the calibration object 31 is imaged the second time with these sensors. In this example, the sensor included in two sets, i.e., the sensor that images the calibration object 31 a plurality of times is the sensors on the front side of the vehicle 1 (the camera C-A and the lidar C-A).

After imaging the calibration object 31, the relative position between the sensors of the same set can be calculated using the data of the relative position between the sensor of each pair and the measurement device A acquired by imaging for each set of sensors. Further, regarding the sensor included in a plurality of sets, i.e., the sensors on the front side of the vehicle 1 (the camera C-A and the lidar C-A) in this example, the data of the relative positions with the measurement device A when changing the position/attitude and imaging the calibration object 31 as a sensor of a different set can be used to calculate the relative position (position/attitude change) between positions/attitudes of the sensor itself by each imaging. The relative positions between sensors in different sets can be calculated on the basis of the calculating results of these relative positions.

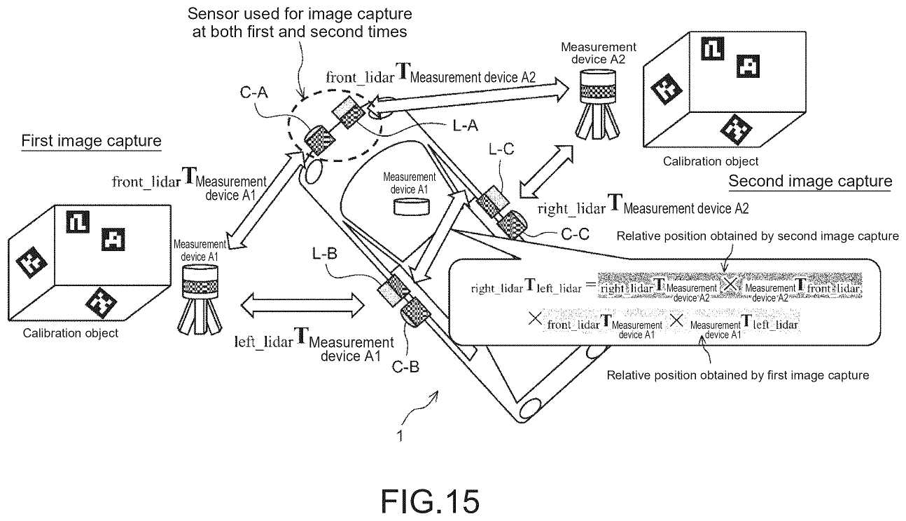

An example of the procedure for calculating the relative position between the lidar L-B on the left side that has imaged the calibration object 31 the first time and the lidar L-C on the right side that has imaged the calibration object 31 the second time will be described with reference to FIG. 15.

Although not the calibration object 31 but the sensors (the vehicle 1) are caused to move between the first imaging and the second imaging in FIG. 13 and FIG. 14, it is the same as the case where calibration objects 31-1 and 31-2 having the same structure are used to be imaged as shown in FIG. 15, because the observation is relative. Assumption is made that the calibration object 31-1 is placed at the same relative position to the vehicle 1 as that in the first imaging shown in FIG. 13. Assumption is made that the calibration object 31-2 is placed at the same relative position to the vehicle 1 as that in the second imaging shown in FIG. 14. Further, assumption can be made that as the measurement device A, the measurement device A1 and the measurement device A2 installed at the same relative positions to the calibration object 31-1 and the calibration object 31-2, respectively, were used.

At this time, similarly as described in the above-mentioned formula (3), the relative positions between the measurement device A1 that has imaged the calibration object 31-1 and the lidars L-A (front_lidar) and L-B (left_lidar) are represented as follows, as shown in FIG. 15.
_{front_lidar}T_{measurement device A1}
_{left_lidar}T_{measurement device A1}

Similarly, the relative positions between the measurement device A2 that has imaged the calibration object 31-2 and the lidar L-A (front_lidar) and the L-C (right_lidar) are represented as follows, as shown in FIG. 15.
_{front_lidar}T_{measurement device A2}
_{right_lidar}T_{measurement device A2}

Therefore, the relative position _{right_lidar}T_{left_lidar} between the lidar L-B (left_lidar) and the lidar L-C (right_lidar) can be obtained by the following formula, as shown in FIG. 15, using the relative position between the measurement device A1 and the lidar L-A (front_lidar) and the relative position between the measurement device A2 and the lidar L-A (front_lidar).

$${}_{right \_ lidar} {T}_{left \_ lidar} = ( {}_{right \_ lidar} {T}_{measurement device A 2} ) \times ( {}_{measurement device A 2} {T}_{front \_ lidar} ) \times {}_{front \_ lidar} {T}_{measurement device A 1} ) \times ( {}_{measurement device A 1} {T}_{left \_ lidar} )$$

With the above method, even in the case where the sensors are divided into a plurality of sets and a calibration object is imaged a plurality of times for each set of sensors, the relative position between sensors in different sets can be calculated when a sensor of each set also belongs to another set.

### Modified Example 2

In the case where the sensors on the entire periphery are to be calibrated as in the sensors or the like installed in the automobile vehicle 1 shown in FIG. 1, there is a demand to set an origin at a position different from the position of the sensor and acquire the relative position of each sensor from the origin. However, it is often difficult to actually measure the origin, e.g., the center of the rear wheel axle. Further, even if the origin is desired to be obtained from the sensor to be calibrated, it is often difficult to obtain the origin because the sensor is embedded.

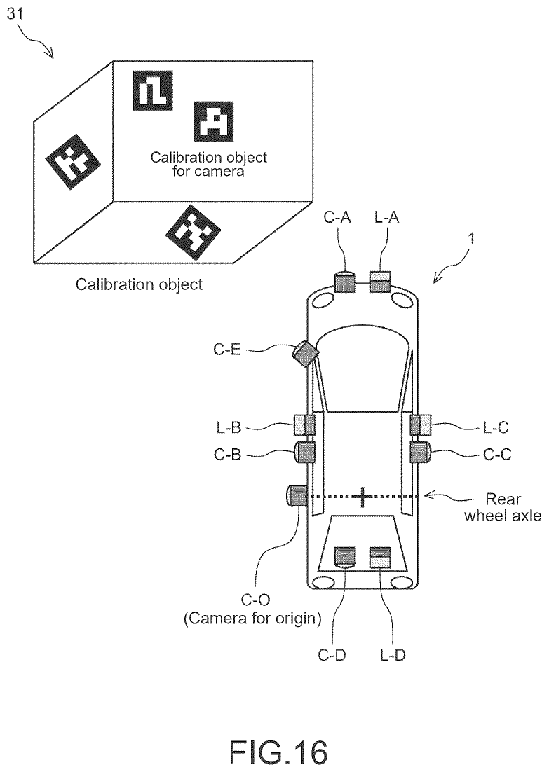

In this regard, in order to realize such a demand, it only needs to install a sensor such as a camera or lidar for an origin (referred to as a sensor for an origin) at a position to be set as the origin or a position where the position to be set as the origin can be easily calculated (e.g., a position physically linked to the origin) and calibrate the sensor for an origin in the same manner as that for the other sensors. FIG. 16 is a diagram describing such a case. Note that in FIG. 16, the components common to those in FIG. 1 are denoted by the same reference symbols and description thereof is omitted. In FIG. 16, the position of the center of the rear wheel axle of the vehicle 1 is set as the origin. In this case, a camera for an origin C-0 is installed at the center of the rear wheel (axle part) as a sensor for an origin and is calibrated in the same manner as that for the above-mentioned other sensors. Since the position of the center of the rear wheel axle is a point reached by moving from the position of the camera for an origin C-0 to the center of the rear wheel along the rear wheel in parallel, the position of the center of the rear wheel axle can be set as the origin by calculating the length from the design value and causing it to move by the amount of the length.

### <Examples of Configuration Combinations>

Note that the present technology may also take the following configurations.

(1) An information processing apparatus, including:
a processing unit that calculates a relative positional relationship between a first sensor and a second sensor on a basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

(2) The information processing apparatus according to (1) above, in which
the processing unit calculates a relative positional relationship between the first sensor and the third sensor on a basis of the first sensor data and the third sensor data, calculates a relative positional relationship between the second sensor and the third sensor on a basis of the second sensor data and the third sensor data, and calculates the relative positional relationship between the first sensor and the second sensor on a basis of the relative positional relationship between the first sensor and the third sensor and the relative positional relationship between the second sensor and the third sensor.

(3) The information processing apparatus according to (1) or (2) above, in which
at least part of a measurement range of the third sensor is common to part of the measurement ranges of the first sensor and the second sensor.

(4) The information processing apparatus according to any one of (1) to (3) above, in which
the calibration object is placed in a range where the measurement range of the first sensor and the measurement range of the second sensor are not common.

(5) The information processing apparatus according to any one of (1) to (4) above, in which
the third sensor measures information including a three-dimensional shape and color or reflection intensity of the calibration object.

(6) The information processing apparatus according to any one of (1) to (5) above, in which
the third sensor is a laser ranging sensor.

(7) The information processing apparatus according to any one of (1) to (6) above, in which
the first sensor and the second sensor are either one or both of a camera and a lidar.

(8) The information processing apparatus according to any one of (1) to (7) above, in which
the calibration object includes a plurality of markers.

(9) The information processing apparatus according to (8) above, in which
at least one of the first sensor or the second sensor is a sensor that does not measure information of the marker.

(10) An information processing method for an information processing apparatus that includes a processing unit, including:
calculating, by the processing unit, a relative positional relationship between a first sensor and a second sensor on a basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

(11) A measurement system, including:
a first sensor that measures spatial information;
a second sensor that measures spatial information;
a calibration object that is placed in at least part of measurement ranges of the first sensor and the second sensor;
a third sensor that measures three-dimensional information of the calibration object; and
a processing unit that calculates a relative positional relationship between the first sensor and the second sensor on a basis of first sensor data, second sensor data, and third sensor data, the first sensor data and the second sensor data being respectively acquired by the first sensor and the second sensor, the third sensor data being acquired by the third sensor.

Note that this embodiment is not limited to the above-mentioned embodiment, and various modifications can be made without departing from the essence of the present disclosure. Further, the effects described in the present specification are merely examples and not limitative, and other effect may be exhibited.

### REFERENCE SIGNS LIST

1 vehicle
31 calibration object
51 signal processing device
61-C image capturing unit
61-L lidar signal reception unit
62-C camera position estimation unit
62-L lidar position estimation unit
63 relative position conversion unit,
A measurement device
C-A, C-B, C-C, C-D, C-E camera
L-A, L-B, L-C, L-D lidar

What is claimed is:

1. An information processing apparatus, comprising:
a processing unit that calculates a relative positional relationship between a first sensor and a second sensor on a basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

2. The information processing apparatus according to claim 1, wherein
the processing unit calculates a relative positional relationship between the first sensor and the third sensor on a basis of the first sensor data and the third sensor data, calculates a relative positional relationship between the second sensor and the third sensor on a basis of the second sensor data and the third sensor data, and calculates the relative positional relationship between the first sensor and the second sensor on a basis of the relative positional relationship between the first sensor and the third sensor and the relative positional relationship between the second sensor and the third sensor.

3. The information processing apparatus according to claim 1, wherein
at least part of a measurement range of the third sensor is common to part of the measurement ranges of the first sensor and the second sensor.

4. The information processing apparatus according to claim 1, wherein
the calibration object is placed in a range where the measurement range of the first sensor and the measurement range of the second sensor are not common.

5. The information processing apparatus according to claim 1, wherein
the third sensor measures information including a three-dimensional shape and color or reflection intensity of the calibration object.

6. The information processing apparatus according to claim 1, wherein
the third sensor is a laser ranging sensor.

7. The information processing apparatus according to claim 1, wherein
the first sensor and the second sensor are either one or both of a camera and a lidar.

8. The information processing apparatus according to claim 1, wherein
the calibration object includes a plurality of markers.

9. The information processing apparatus according to claim 8, wherein
at least one of the first sensor or the second sensor is a sensor that does not measure information of the marker.

10. An information processing method for an information processing apparatus that includes a processing unit, comprising:
calculating, by the processing unit, a relative positional relationship between a first sensor and a second sensor on a basis of third sensor data, first sensor data, and second sensor data, the third sensor data being obtained by a third sensor that measures three-dimensional information regarding a calibration object disposed in at least part of measurement ranges of the first sensor and the second sensor that measure spatial information, the first sensor data and the second sensor data being respectively acquired by the first sensor and the second sensor.

11. A measurement system, comprising:
a first sensor that measures spatial information;
a second sensor that measures spatial information;
a calibration object that is placed in at least part of measurement ranges of the first sensor and the second sensor;
a third sensor that measures three-dimensional information of the calibration object; and
a processing unit that calculates a relative positional relationship between the first sensor and the second sensor on a basis of first sensor data, second sensor data, and third sensor data, the first sensor data and the second sensor data being respectively acquired by the first sensor and the second sensor, the third sensor data being acquired by the third sensor.
